(19) United States
(12) Patent Application Publication
(10) Pub. No.: US 2025/0205962 A1
(43) Pub. Date: Jun. 26, 2025

(54) METHOD FOR THE PRODUCTION OF THERMOFORMED PLASTIC PARTS FROM POLYETHYLENE TEREPHTHALATE

(71) Applicant: Thermapet Technologies PTE. LTD, Singapore (SG)

(72) Inventor: Florian Bamberger, St. Pantaleon (AT)

(21) Appl. No.: 18/849,950

(22) PCT Filed: Mar. 8, 2023
(86) PCT No.: PCT/AT2023/060066

§ 371 Date: Sep. 23, 2024

(30) Foreign Application Priority Data
Mar. 25, 2022 (AT) A 50196/2022

(51) Int. Cl. B29C 51/04; B29C 55/06; B29K 67/00; B29L 31/00

(52) U.S. Cl. CPC B29C 51/04; B29C 55/06; B29K 2067/003; B29K 2995/0026; B29K 2995/0039; B29L 2031/712

(57) ABSTRACT

A method for the production of thermoformed plastic parts from nucleation-free, amorphous polyethylene terephthalate includes a feed step in which a semi-finished product (1) having a predetermined semi-finished product width is first fed in a machine direction (MD) running parallel to the longitudinal direction of the semi-finished product to a processing section (3) of a thermoforming apparatus comprising a thermoforming tool and is then heated there in at least one heating step to a stretching temperature of 90-180° C., and is, as a function of the set stretching temperature, actively stretched at a degree of stretching of 1.2-5.0 in the machine direction (MD) in at least one stretching step. The at least one heating step takes place simultaneously with or precedes the at least one stretching step, and then, in a forming step, the semi-finished product (1) stretched in the processing section (3) is formed with the aid of the cooled hot thermoforming tool and is quenched to a temperature of at least 30° C. below the glass transition temperature of the polyethylene terephthalate used.

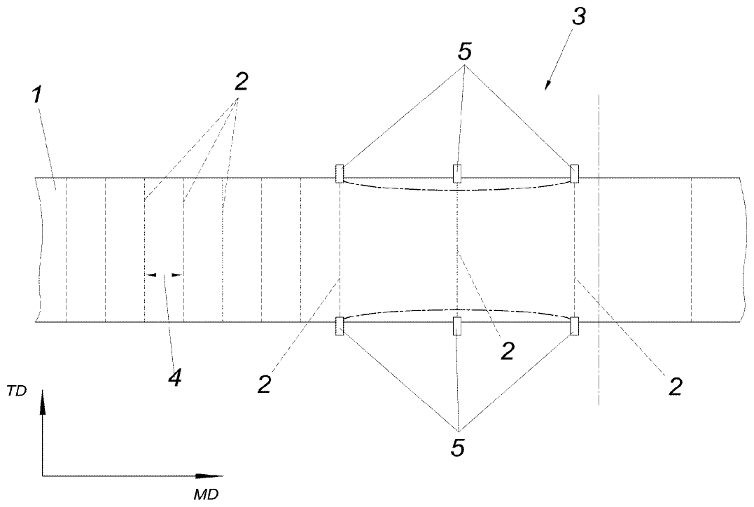

### TECHNICAL AREA

The invention relates to a method for the production of thermoformed plastic parts, which are made of nucleating agent-free amorphous polyethylene terephthalate and are fully pure grade recyclable.

### STATE OF THE ART

For the production of plastic parts such as plastic cups or plastic containers, manufacturing processes known as thermoforming are generally used. In connection with polyethylene terephthalate (PET), for example, a film- or sheet-shaped semi-finished plastic product is first preheated to up to 90° C., then fed via a transport system to a thermoforming apparatus, where it is usually formed in two steps. In a first step, the semi-finished PET product is gradually heated to over 200° C. to create the conditions for heat-induced crystallization and thus ultimately achieve high temperature resistance of the containers. The semi-finished product is further formed in a thermoforming tool, after which in a second step the semi-finished product is rapidly cooled in a cooled thermoforming tool. As a result of these measures, crystallization of the PET can be achieved to improve the mechanical properties, including a temperature resistance of at least 120° C. However, in order to make such processes economical, nucleating agents, e.g. in the form of nucleating inorganic filler particles and/or polymer-based nucleating agents, must already be added to the PET during the extrusion process of the corresponding semi-finished products in order to minimize the heat-induced crystallization time, which would otherwise be more than 15 seconds, depending on the target product. However, the use of such additives makes recycling more difficult, because it is not possible to pure grade recycle. Another disadvantage is that, due to crystallization, it is only possible to produce opaque, but not transparent plastic parts from PET.

In addition, thermoforming processes are known which also allow the production of transparent plastic parts using amorphous PET. The disadvantage, however, is that plastic parts produced in this way are not suitable for use in microwaves because of their low heat resistance up to a maximum of 60-70° C. and their undesirable tendency to shrink at temperatures of 62° C. and above.

There are also processes for the production of so-called biaxially oriented PET films, in which a PET film is first preheated to up to 90° C. and then stretched biaxially, i.e. both in the machine direction and in the transverse direction, by a corresponding stretching device. Auxiliary materials are usually added to the PET to facilitate the heating of the stretching gap, which heating is usually carried out with the aid of an infrared heater. The stretching process induces crystallization of the PET to specifically influence the property profile of the film. In the course of a thermal post-treatment, the PET film is subsequently heated up to 200° C. or higher. This relieves residual stresses in the film caused by crystallization, which can reduce the tendency to shrink. Due to the necessary thermal post-treatment and the associated high temperatures, however, a correspondingly high energy input is required.

### PRESENTATION OF THE INVENTION

There is thus a need to create a method of the type described at the outset which, despite economical cycle times and with relatively low energy consumption, enables the production of thermoformed plastic parts which can be pure grade recycled and which, with sufficient, visually appealing transparency, are also suitable for use in microwaves or for applications with a temperature resistance of 120-145° C. required for this purpose.

The invention solves the problem in that, in a feed step, a semi-finished product, in particular a film- or plate-shaped semi-finished product, with a predetermined semi-finished product width is first fed in a machine direction running parallel to the longitudinal direction of the semi-finished product to a processing section of a thermoforming apparatus comprising a thermoforming tool and is then heated there in at least one heating step to a stretching temperature of 90-180° C. and, in at least one stretching step, is actively stretched in the machine direction as a function of the set stretching temperature at a degree of stretching of 1.2-5.0 in the machine direction, after which in a forming step the semi-finished product stretched in the processing section is formed with the aid of the cooled thermoforming tool and is quenched to a temperature of at least 30° C. below the glass transition temperature of the polyethylene terephthalate used. Preferably, the thermoforming tool has a tool temperature of 15-20° C. for this purpose. The degree of stretching of 1.2-5.0 means that the semi-finished product is stretched to 1.2-5 times its original reference length in the processing section. Alternatively, the degree of stretching can also be expressed as a percentage, whereby for a reference length defined as 100%, the degree of stretching is accordingly 120-500%.

### WAYS TO CARRY OUT THE INVENTION

The invention is based on the finding that in the case of amorphous, nucleating agent-free PET, the combination of at least one stretching step in the machine direction at a degree of stretching of 1.2-5.0, preferably 3.0-5.0, more preferably 3.5-4.5, particularly preferably 4.4, and at least one heating step to a stretching temperature of 90-180° C., preferably 90-160° C., even more preferably 90-145° C., even more preferably 120-145° C., even more preferably 120-140° C., even more preferably 125-135° C. and especially preferably 130° C., enable advantageous crystallization conditions with regard to a low shrinkage tendency and sufficient transparency of the plastic part produced. The stretching temperature refers in particular to the core temperature of the semi-finished product.

Surprisingly, it has been shown that the strain-induced crystallization triggered by the at least one stretching step in the machine direction, in combination with the at least one heating step, produces a particularly fine-grained lamellar crystal structure which can be fixed by the cooling or quenching in the forming step immediately following the at least one stretching step to a temperature of at least 30° C. below the glass transition temperature of the PET used. Depending on the thickness or strength of the semi-finished product or the finished plastic parts, it can also be provided in principle that, after the at least one stretching step, a brief but intensive reheating of the stretched semi-finished product takes place in a postheating step at a temperature of 120-200° C., preferably 130-200° C., even more preferably 140-200° C., particularly preferably 160-180° C., in order to further improve the crystallization conditions for a temperature resistance of the plastic part of 120-145° C. Accordingly, the higher the temperature selected in this respect, the shorter the residence time in the postheating step. In particular, it can also be provided that the at least one stretching step is immediately followed by the postheating step, after which the forming step immediately follows. The postheating step not only results in further improved temperature resistance of the finished plastic part, but the postheating also enables better formability of the semi-finished product in the forming step.

In principle, additional active stretching of the semi-finished product in the processing section can also take place in a transverse direction running transverse to the machine direction or along the width of the semi-finished product. Preferably, however, active stretching takes place exclusively in the machine direction, while the semi-finished product is fixed in the processing section with respect to the semi-finished product width. Due to the fact that the semi-finished product remains fixed with respect to its semi-finished product width, a normally occurring shrinkage of the semi-finished product with respect to its width, i.e. a decrease of the semi-finished product width due to the longitudinal stretching in machine direction, is prevented during active stretching in machine direction. Thus, in addition to the active stretching in the machine direction, a slight passive stretching in the transverse direction is forced, which together with the active stretching in the machine direction favors the formation of the fine-grained lamellar crystal structures. Preferably, it can be provided that in the at least one stretching step the semi-finished product is fixed in the processing section at the semi-finished product edges opposite each other in the transverse direction. For the purposes of the invention, active stretching means that the active movement of at least one holding element of a stretching device which can be attached to the semi-finished product introduces stretching forces, in particular tensile forces, into the semi-finished product in such a way that the semi-finished product is stretched parallel to the direction of movement of the holding element. In contrast, passive stretching in the transverse direction occurs as an inevitable side effect of active stretching in the machine direction when the semi-finished product is fixed with respect to its semi-finished product width.

In principle, the semi-finished product can also first be overstretched in the machine direction in the processing section, after which the semi-finished product is shrunk again to some degree in a shrinking step after the molecule orientation phase, before the forming step finally takes place. In this way, the advantageous crystallization effects can be further increased, because this measure causes the crystalline chains of the PET material to align in even more ordered structures, which are thus even more advantageous for the material properties of the product. Preferably, the overstretching should take place in such a way that the shrinkage of the semi-finished product in the machine direction following in the shrinking step prior to the forming step is at most 20%, preferably 1 to 20%, even more preferably 5 to 15%, even more preferably 7 to 13%, particularly preferably 10 to 12%. Preferably, the at least one stretching step is immediately followed by the shrinking step, after which the forming step immediately follows.

The shrinkage to be selected depends in particular on the stretch or stretches and the stretching rate or stretching rates at which the sheet semi-finished product was stretched in the at least one stretching step and/or the thickness or strength of the sheet semi-finished product after the at least one stretching step. For example, if the thickness of the plate-shaped semi-finished product after stretching is 1.2 mm, a shrinkage of preferably 10% takes place in the shrinking step. If the thickness of the plate-shaped semi-finished product is, for example, 1.5 mm after stretching, shrinkage of preferably 12% takes place in the shrinking step.

The shrinking step can basically take place at a temperature of 120-200° C., or according to the preferred temperature ranges as indicated above in the postheating step. In particular, the shrinking step can be performed at a temperature of 120-160° C., even more preferably at a temperature of 130-140° C.

Active stretching of the semi-finished product in the machine direction can, as described above, basically be achieved by means of a separate stretching device which introduces the relevant stretching forces, for example, via the end face of the semi-finished product, i.e. via the semi-finished product front bounded by the semi-finished product edges opposite in the transverse direction. Particularly favorable process conditions result, however, when the semi-finished product edges are fixed and positively guided on fastening clips in the processing section and wherein stretching forces for active stretching in the machine direction are introduced into the semi-finished product via the fastening clips. As a result of these measures, both the fixing of the semi-finished product with respect to its semi-finished product width and the introduction of the stretching forces for active stretching in the machine direction take place exclusively via fastening clips which are assigned to the semi-finished product edges opposite in the transverse direction. For example, the fastening clips can be guided and moved via a known chain-based transport system. The transport system can be designed in such a way that the fastening clips are set against the edges of the semi-finished product at the beginning of the processing section and hold them in place. After stretching, the fastening clips release the edges of the semi-finished product at the end of the processing section and are then conveyed away by the transport system. It goes without saying that, as an alternative to the fastening clips, other suitable detachable holding elements can also be used, which can be set against the edges of the semi-finished product with the aid of a transport system and can hold them and release them again.

The plastic parts produced by the method according to the invention can exhibit a shrinkage of no more than 0.5% at a service temperature of 120° C. Consequently, the measures according to the invention allow energy-intensive thermal post-treatment after the stretching step to reduce any residual stresses due to crystallization to be omitted. Depending on the process conditions, plastic parts produced according to the invention can have a Haze value according to ASTM D 1003 of no more than 1%. Overall, the method according to the invention enables the production of plastic parts that are both sufficiently temperature-resistant for microwave use, in particular resistant to thermoforming, and have a visually appealing appearance due to their sufficient transparency. It has also been shown that the strain-induced crystallization rate according to the invention proceeds at a sufficient rate despite the absence of nucleating agents in the PET, so that the cycle times customary for known thermoforming processes can essentially be maintained. Due to the fact that no nucleating agents or auxiliary materials are added to the PET used to improve the heating efficiency, the plastic parts obtained by the method according to the invention can be pure grade recycled.

The method according to the invention can be adapted as required depending on the original semi-finished product thickness or thickness, which for the production of microwave-compatible plastic containers is, for example, 2.5-3.5 mm, with regard to the stretching temperature, the degree of stretching, the stretching rate, the cooling rate, the residence time in the thermoforming tool, etc., and, if necessary, with regard to the temperature and residence time during the postheating step and the temperature, residence time and shrinkage during the shrinking step. Likewise, the number as well as timing or sequence of the respective heating and stretching steps can be adjusted accordingly as needed. For example, the at least one heating step can be performed simultaneously with the at least one stretching step. However, particularly favorable conditions result in principle if the at least one heating step precedes the at least one stretching step in terms of time, i.e. the heating step takes place first and then the stretching step.

To reduce the cycle time, the feeding step and the at least one stretching step can in principle also be carried out simultaneously.

For favorable crystallization conditions, the active stretching of the semi-finished product in the machine direction can take place at a stretching rate of 50-400% per second, preferably 90-350% per second, even more preferably 200-350% per second, depending on the original thickness of the semi-finished product in the at least one stretching step. In principle, an increase in the stretching temperature should also result in an increase in the stretching rate, and vice versa.

The stretching rate should basically be set as fast as the material at hand allows, depending on the corresponding material thickness, etc. The faster the molecular orientation of the PET material takes place after stretching, the higher the thermal energy required later to induce a shrinkage process in the finished formed end product. Accordingly, higher stretching rates can increase the temperature resistance of the final product. In principle, known plastic thermoforming apparatuses can be used to carry out a method according to the invention, which, for example, comprise not only a thermoforming tool but also a corresponding feed or transport system for the semi-finished product and, if necessary, a punching device for punching out the formed plastic parts.

In the drawing, the object of the invention is shown, for example, in a schematic top view of a semi-finished product stretched in a processing section of a thermoforming apparatus.

A method according to the invention is used, for example, for the production of thermoformed containers made of nucleating agent-free, amorphous PET. Such containers have a haze value according to ASTM D 1003 of no more than 1% and a shrinkage at a service temperature of 120° C. of no more than 0.5%. Accordingly, the containers have a visually appealing transparency and are also suitable for use in microwaves. As no nucleating agents or auxiliary materials are added to the PET used to improve the heating efficiency, the cups obtained by the method according to the invention can be pure grade recycled at the end of their service life.

The drawing shows a schematically illustrated semi-finished product 1 in the form of a PET film. The semi-finished product 1 can in principle be supplied as a continuous film roll or continuous film strip. The dashed reference lines 2 on the semi-finished product 1, running in a transverse direction TD with respect to the width of the semi-finished product, are intended to illustrate that the semi-finished product 1 is stretched in a processing section 3 of a thermoforming apparatus, which is not shown in greater detail, in a machine direction MD running parallel to the longitudinal direction of the semi-finished product. The processing section 3 is indicated by two dash-dotted lines also running in the transverse direction TD. In the present embodiment, the semi-finished product 1 is stretched with respect to a reference length 4 defined between two reference lines 2 in the processing section 3 at a degree of stretching of 4.4 or 440% in machine direction MD, as can be seen from the increased distance between the reference lines 2 in the processing section 3.

The semi-finished product 1 is held on the edges of the semi-finished product in the processing section 3 by fastening clips 5, which are indicated schematically, so that the semi-finished product 1 is fixed in terms of its width. The fastening clips 5, which can be moved in the machine direction MD in the processing section 3, for example with the aid of a chain drive, introduce stretching forces into the semi-finished product 1 for active stretching in the machine direction MD. Active stretching in machine direction MD only would normally cause the PET film to shrink with respect to its width, i.e. a reduction in the width of the semi-finished product 1, as indicated by the dash-dotted tapering of the semi-finished product 1 in the processing section 3. However, the fact that the semi-finished product 1 remains fixed in terms of its semi-finished product width prevents such a shrinkage with respect to the width of the semi-finished product 1. Consequently, in addition to active stretching in the machine direction MD, a slight passive stretching in the transverse direction TD is forced. The fastening clips are set against the edges of the semi-finished product at the beginning of the machining section 3, so that these are held by the fastening clips 5. After stretching, the fastening clips 5 release the edges of the semi-finished product at the end of the processing section 3. In principle, the number of fastening clips 5 or detachable holding elements used can be freely selected depending on the desired process conditions and product properties. For example, depending on the application for the process conditions, it can also be advantageous to have as many fastening clips 5 or detachable holding elements as possible in the processing section 3, so that the set overall degree of stretching results from several smaller partial stretches in the machine direction MD.

A heating step is carried out at the same time as or prior to the stretching step, whereby the semi-finished product 1 is heated to a stretching temperature of approx. 130° C. The semi-finished product 1 is then shaped by means of a cooled thermoforming tool. Immediately after the stretching step, the semi-finished product 1 is formed in a forming step with the aid of a cooled thermoforming tool, which is not shown in greater detail, and is quenched to a temperature of at least 30° C. below the glass transition temperature of the PET used. For this purpose, the water-cooled thermoforming tool is temperature-controlled to a tool temperature of 15° C.

Alternatively, the stretching step can also be immediately followed by a postheating step, in which the stretched semi-finished product 1 is briefly heated intensively at a temperature of 120-200° C. The postheating step is then immediately followed by the forming step.

According to a further alternative, the stretching step can be followed by a shrinking step, whereby the semi-finished product 1 undergoes a shrinkage of at most 20% in machine direction MD. This can take place at a temperature of 120-200° C. The shrinking step is then immediately followed by the forming step.

After the forming step, the formed semi-finished product 1 is transported further in machine direction MD and fed to a punching device, where the finished plastic containers are punched out of the semi-finished product 1.

1. A method for the production of thermoformed plastic parts of nucleating agent-free amorphous polyethylene terephthalate material, said method comprising:
a feed step including feeding a semi-finished product in film or sheet form and having a predetermined semi-finished product width in a machine direction parallel to a longitudinal direction of the semi-finished product to a processing section of a thermoforming apparatus comprising a thermoforming tool;
heating the semi-finished product in the thermoforming apparatus in at least one heating step to a stretching temperature of 90-180° C.;
stretching the semi-finished product in at least one stretching step as a function of the set stretching temperature at a degree of stretching of 1.2-5.0 in the machine direction;
wherein the at least one heating step takes place simultaneously with the at least one stretching step or precedes the at least one stretching step in time; and then
cooling the thermoforming tool; and
a forming step, that includes forming the semi-finished product stretched in the processing section using the cooled thermoforming tool and quenching the semi-finished product to a temperature of at least 30° C. below a glass transition temperature of polyethylene terephthalate in the semi-finished product.

2. The method according to claim 1, wherein the at least one stretching step is immediately followed by the forming step.

3. The method according to claim 1, wherein the method further comprises
a shrinking step between the at least one stretching step and the forming step, wherein the semi-finished product undergoes a shrinkage of at most 20% in the machine direction.

4. The method according to claim 3, wherein the shrinking step takes place at a temperature of 120-200° C.

5. The method according to claim 1, wherein the stretching of the semi-finished product is actively stretching the semi-finished product in the processing section exclusively in the machine direction, while the semi-finished product is fixed in the processing section with respect to the semi-finished product width.

6. The method according to claim 5, wherein in the stretching step the semi-finished product is fixed in the processing section at edges of the semi-finished product that are opposite each other in a transverse direction extending transversely to the machine direction.

7. The method according to claim 5, wherein edges of the semi-finished product are fixed and positively guided in the machining section on releasable holding elements, and stretching forces for active stretching in the machine direction are introduced into the semi-finished product via the holding elements.

8. The method according to claim 5, wherein, in the stretching step, the active stretching of the semi-finished product in the machine direction takes place at a stretching rate of 50-400% per second.

9. A plastic part produced by the method according to claim 1, wherein the shrinkage of the plastic part at a use temperature of 120° C. is at most 0.5%.

10. The plastic part according to claim 9, wherein the plastic part has a Haze value according to ASTM D 1003 that is at most 1%.

11. The plastic part according to claim 9, wherein the plastic part is a plastic container or plastic vessel.

12. The plastic part according to claim 11, wherein the plastic part has a Haze value according to ASTM D 1003 that is at most 1%.

13. The method according to claim 2, wherein the stretching of the semi-finished product is actively stretching the semi-finished product in the processing section exclusively in the machine direction while the semi-finished product is fixed in the processing section with respect to the semi-finished product width.

14. The method according to claim 3, wherein the stretching of the semi-finished product is actively stretching the semi-finished product in the processing section exclusively in the machine direction while the semi-finished product is fixed in the processing section with respect to the semi-finished product width.

15. The method according to claim 4, wherein the stretching of the semi-finished product is actively stretching the semi-finished product in the processing section exclusively in the machine direction while the semi-finished product is fixed in the processing section with respect to the semi-finished product width.

16. The method according to claim 6, wherein edges of the semi-finished product are fixed and positively guided in the machining section on releasable holding elements, and stretching forces for active stretching in the machine direction are introduced into the semi-finished product via the holding elements.

17. The method according to claim 16, wherein the releasable holding elements, include fastening clips.

18. The method according to claim 7, wherein the releasable holding elements, include fastening clips.

19. The method according to claim 5, wherein, in the stretching step, the active stretching of the semi-finished product in the machine direction takes place at a stretching rate of 90-350% per second.

20. The method according to claim 5, wherein, in the stretching step, the active stretching of the semi-finished product in the machine direction takes place at a stretching rate of 200-350% per second.
